(19) United States
(12) Patent Application Publication
(10) Pub. No.: US 2017/0300564 A1
(43) Pub. Date: Oct. 19, 2017

(54) CLUSTERING FOR SOCIAL MEDIA DATA

(71) Applicant: Sprinklr, Inc., New York, NY (US)

(72) Inventors: Xin Feng, New York, NY (US); Murali Swaminathan, New York, NY (US); Ragy Thomas, New York, NY (US)

(21) Appl. No.: 15/133,090

(22) Filed: Apr. 19, 2016

(51) Int. Cl. G06F 17/30

(52) U.S. Cl. CPC G06F 17/30705; G06F 17/30038; G06F 17/30684

(57) ABSTRACT

Systems and methods that enable automated clustering and topic analysis from social media data. In some embodiments, methods are provided to use web URLs configuration to control global hierarchical domain creations. In some embodiments, methods are provided to represent global hierarchical domains with average term distribution vector. In some embodiments, methods are provided to detect input data records domain's by calculating a similarity index between input data and each global hierarchical domain term distribution vector. In some embodiments, methods are provided to use Single Value Decomposition to detect topics for input data set to detect topic words. In still further embodiments, methods are provided to use POS tag information to find noun in topic word and search and retrieve the most common web pages and determine topic word order.

### BACKGROUND

### 1. Field

The invention generally relates to systems and methods for clustering and topic analysis of social media data.

### 2. Related Art

Huge amounts of raw data are generated daily by individuals, groups and organizations on social media networks. A tremendous amount of information is embedded inside this raw data. This information can be used in a wide range of areas, such as understanding customer demands, improving customer relations, conducting market research, estimating business operating efficiency, eliminating risk, improving productivity, and more. Social media data may also contain behavior and relationship information about individuals and organizations. Further, such data may also be very valuable in product-planning and business operations.

### SUMMARY

The following summary of the invention is included in order to provide a basic understanding of some aspects and features of the invention. This summary is not an extensive overview of the invention and as such it is not intended to particularly identify key or critical elements of the invention or to delineate the scope of the invention. Its sole purpose is to present some concepts of the invention in a simplified form as a prelude to the more detailed description that is presented below.

A system and methods are herein disclosed that enable extraction of domain and topic information from massive social media data.

According to some embodiments, methods are provided for automated clustering from social media data.

According to some embodiments, methods are provided for automated topic analysis from social media data.

According to some embodiments, methods are provided for substantially automated identification and analysis of user sentiment based on social media interactions.

According to some embodiments of the invention, a social media data clustering system is disclosed that includes a topic analysis server for splitting input social media data into topics using topic analysis; a frequency processor for generating a term-document frequency matrix, document and collection frequency vectors from the topics and transform the term-document frequency matrix and document and collection frequency vectors into a single entity for frequency calculations; and a latent semantic analysis (LSA) processor for deriving implicit text representation of text semantics based on term and document distribution information generated by the frequency processor.

The social media data clustering system may further include a source container, wherein the topic analysis server receives the social media data from the source container.

The social media data clustering system may further include a target container, wherein the implicit text representation of text semantics derived by the LSA processor is stored in the target container.

According to other embodiments of the invention, a computer-implemented comprising is disclosed that includes generating a universal hierarchical topic domain dataset based on social media data records; standardizing input raw social media data records; clustering the standardized social media data records into multiple groups based on a record similarity matrix; and deriving implicit text representation of text semantics based on latent semantic analysis (LSA) of the clustered social media data records.

The computer-implemented method of claim 4, wherein the multiple groups are clusters of topic domain data sets of the social media data records.

The generating the universal hierarchical topic domain set may be performed by a topic analysis server.

The clustering the standardized social media data records into multiple groups based on a record similarity index may be performed by a frequency processor.

Delivering implicit text representation of text semantics based on latent semantic analysis (LSA) may be performed by a latent semantic analysis (LSA) processor.

The method may further include using single value decomposition to detect topic words in the social media data records.

The standardizing may include at least one of converting text to lowercase, eliminating irregular spacing, removing stop words, correcting misspellings and replacing words with corresponding root words.

The method may further include generating a term-document frequency matrix for each standardized social media data record.

The method may further include transforming the term-document frequency matrix using term frequency and inversed document frequency (TF-IDF).

The method may further include calculating the record similarity matrix using the transformed term-document frequency matrix.

The method may further include clustering the data records by ranking a popularity index of each social media data record.

The term-document frequency matrix may be used to introduce a single value decomposition technique for topic analysis.

The method may further include using POS tag information to identify nouns in the term-document frequency matrix. A POS tag module may be used to define the POS tag information. The POS tag information may further be used to retrieve most common web pages and topic word order.

Generating the universal hierarchical domain dataset may use web uniform resource locators (URLs) to control the generating.

The term-document frequency matrix may include average term distribution vectors.

The group of each social media data record may be determined by calculating a similarity index between each social media data record and each term distribution record.

### BRIEF DESCRIPTION OF THE DRAWINGS

The accompanying drawings, which are incorporated into and constitute a part of this specification, illustrate one or more examples of embodiments and, together with the description of example embodiments, serve to explain the principles and implementations of the embodiments.

FIG. 1 is a schematic block diagram of a social media data clustering system in accordance with some embodiments of the invention;

FIG. 2 is a flow chart of a social media data clustering method in accordance with some embodiments of the invention; and

FIG. 3 is a schematic diagram showing a diagrammatic representation of a machine in the exemplary form of a computer system according to an embodiment of the invention.

### DETAILED DESCRIPTION

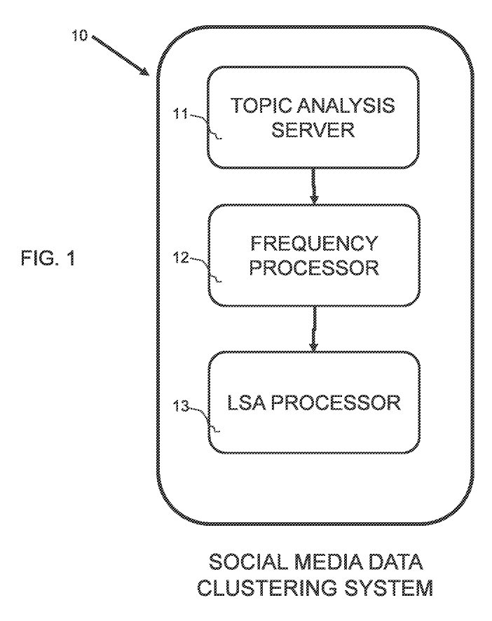

FIG. 1 is a schematic block diagram of a social media data clustering system 10. As shown in FIG. 1, the social media data clustering system 10 includes a topic analysis server 11 for splitting input data into topics using topic analysis; a frequency processor 12 is then used for generating a term-document frequency matrix, document and collection frequency vectors from the derived topics, to transform and combine them into a single entity for frequency calculations; and a Latent Semantic Analysis (LSA) processor 13 for deriving implicit text representation of text semantics based on term and document distribution generated by the frequency processor. The system 10, as shown in FIG. 1, is adapted to consume or process data from a specific container in a distributed network cache, referred to as source container 15, and push the analyzed results to another container, referred to as target container 16.

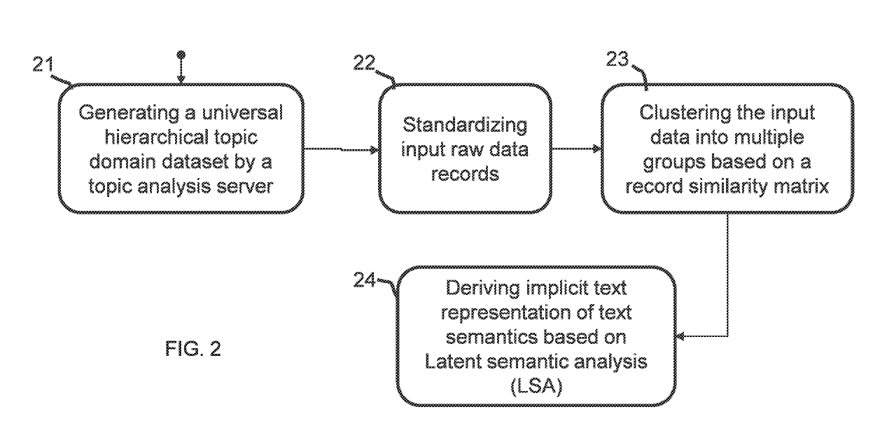

FIG. 2 is a flow chart diagram of a social media data clustering method in accordance with some embodiments of the invention. As shown in FIG. 2, a universal hierarchical topic domain dataset is generated (block 21). In one embodiment, the dataset is generated by the topic analysis server 11 in the social media data clustering system 10 of FIG. 1. Next, input of the raw data records in the dataset are standardized (block 22). In one embodiment, the dataset is the dataset received from the topic analysis server 11 of FIG. 1. Once standardized, the data is sorted and clustered into multiple groups based on a record similarity matrix (block 23). An implicit text representation of text semantics is derived based on Latent Semantic Analysis (LSA) to generate the usable social media clusters of topic domain data sets (block 24). In one embodiment, the implicit text representation of text semantics is performed by the LSA processor 13. It will be appreciated that alternative or additional steps may be implemented to further refine and optimize the results based on the users' requirements.

As used herein, domain and topic analysis is a process that utilizes general mathematical clustering and dimension reduction algorithms within the social media data clustering system 10 to derive one or more topic representations. The input is usually harvested from multiple messages collected from one or more social media sites and stored in a source data container 15. The output from analysis typically includes topics and/or domains derived from the input data. The output is stored in a target data container 16. The methodology used in topic analysis within the topic analysis server 11 can be applied equally well to any other electronic documents like web pages, emails, blogs, news, articles, surveys, etc. The sources of data, length of each data object and the format of the data are generally irrelevant in topic analysis. The input data from the source container 15 is transformed and normalized by the topic analysis server before being fed for analysis. In order to simplify the method description and algorithm derivation, each piece of data is defined as record. The topic analysis algorithm assumes there are N records and each record has Lᵢ words, where N is positive integer 1≦N<∞ and Lᵢ is number words in record i (1≦Lᵢ<∞). Generally, topic analysis server can be treated as a black box, whereby the user only needs to feed the normalized records into the topic analysis server 11 and optionally input the number of topics (k) s/that need to be retrieved from the data. The topic analysis server 11 clusters the input data into groups based on similarity, and derives single distinct topic(s) for each group. If the user does not explicitly input K, topic analysis server 11 will use an internal similarity criterion to split input data before conducting topic analysis.

### Universal Hierarchical Topic Domains Buildup

In order to accurately detect a topic and its corresponding domain for any random data input, the topic analysis server 11 generates a universal hierarchical topic domain dataset 21, as explained above, for example, with reference to FIG. 2. This universal hierarchical topic domain dataset 21 is essential to detecting topic domains using a similarity index and subsequent algorithm(s) for accuracy analysis. The dataset buildup is a dynamic and iterative process, to which topic analysis server 11 will continually bring new document and statistics, and node representation information will be calculated and updated consequently. It is close to impossible to build this huge dataset manually using manual grading or supervised learning, since it demands too many resources. The topic analysis server 11 uses a web sniffer engine to dynamically sniff configured web URLs, download all nested web pages and extract text from web pages. It then abstracts universal hierarchical topic domain information and persistent it within each node. The sniff process first fetches the web page for a given URL, and then runs through the page and finds out all links in current page. The topic analysis server 11 may then check each link and detect whether it is within the current context, and if so, it will download the linked page. The process is repeated until all pages within the current context are exhausted or the configured nest level is reached. This can be categorized as semi-supervised learning since it allows users to input URLs and predefined domains and their parameters for given URLs. This may provide a substantial saving of processing resources, since it is relatively easy to classify web URLs manually. Some exemplary URLs and domain configuration are shown in Table 1.

TABLE 1
Sample for URLs and topic domain configuration

| URL | Domain |
|---|---|
| http://www.cnn.com/politics | Politics |
| http://www.cnn.com/tech | Technology |
| http://www.cnn.com/health | Health |
| http://www.cnn.com/entertainment | Entertainment |
| http://bleacherreport.com/ | Sports |
| http://espn.go.com/ | Sports |
| http://espn.go.com/college-football/ | Sports/college- |
| | football |
| http://espn.go.com/college-football/rankings | Sports/college- |
| | football/rankings |
| http://scores.espn.go.com/ncf/scoreboard | Sports/college- |
| | football/scoreboard |
| http://espn.go.com/college-football/standings | Sports/college- |
| | football/standings |
| http://espn.go.com/college-football/teams | Sports/college- |
| | football/teams |

As can be seen in Table 1, it is possible for a single topic domain to have multiple URLs and, further, that whole topic domains are constructed hierarchically. There should be only one instance of topic domain structure in a server no matter how many concurrent analysis processes are attached to the topic analysis server 11. In Table 1, the node ‘sports’ contains college-football category which in turn contains other categories such as rankings, scoreboard, standings and teams etc. Any single node can contain multiple documents and categories. The leaf node is defined as the nodes that contain only documents but not categories. This definition of hierarchical nodes is similar to file system. The node is equivalent to a directory in a file system. Each directory can contain files and other directories. The directory that only contains files and do not contain sub-directories is called a leaf node in this context. There are several pieces of information stored in each node described, as follows:
Current node text representation
Current node name
Current node id
Last update time
Array of most frequent used noun words in current nodes (20)
Total number of documents in current node
Links to the branches/categories in current node
Links to individual document
Total word count for all documents in current node
Term by document count in current node
A double array stored normalized TF-IDF values of word frequency distribution.
   The method for calculating TH-IDF values is described below.

The root node is defined as “ROOT” and it has multiple categories and each category can have one or more subcategories. Each subcategory can further have one or more sub-subcategories and process is repeated indefinitely. The depth of tree is unlimited, and the number of subcategories within each node are also unlimited. The minimum number of documents in each leaf node must be no smaller than about 1,000 but should not exceed about 10,000. Search and retrieve engine are deployed dynamically to retrieve additional pages if needed. In order to make users understand the basic structure of our topic domain construction process, the top most categories and some subcategories for a simple node are listed below, as examples of top level subcategories for business:
U.S. States
Shopping and Services
International
Employment and Work
Business and Economy
Entertainment
Finance and Investment
Health
Computers and Internet
Marketing and Advertising
Arts
Recreation
Society and Culture
Social Science
Government
Education
News and Media
Reference
Science
Business to Business
   In addition, by focusing on the last subcategory (Business to Business), the subcategories may be derived as shown, for example, in Table 2:

TABLE 2
Subcategories under “Business to Business” Node

| | |
|---|---|
| dᵢ Communications and Networking | Printing |
| Manufacturing | Scientific |
| Computers | Storage |
| Environment | Quality |
| Financial Services | News and Media |
| Emergency Services | Franchises |
| Corporate Services | Office Supplies and Equipment |
| Retail Management | Law |
| Industrial Supplies | Electronic Commerce |
| Construction | Real Estate |
| Health Care | Outdoors |
| Electronics | Investigative Services |
| Transportation | Navigation |
| Shipping | Gifts and Occasions |
| Energy | Management |
| Marketing and Advertising | Museums and Fine Art |
| Cleaning | Wholesalers |
| Event Planning and Production | Labor |
| Agriculture | Writing and Editing |
| Education | Travel |
| Conventions and Trade Shows | Auctions |
| Entertainment and Media Production | Home and Garden |
| Design | Signage |
| Furniture | Information |
| Engineering | Funerals |
| Religious Supplies and Services | Consumer Electronics |
| Architecture | Gaming |
| Chemicals and Allied Products | Flowers |
| Trade | Research and Development |
| Jewelry | Hospitality Industry |
| Automotive | Government |
| Business Opportunities | Aerospace and Defense |
| Security | Speakers |
| Personal Care | Mining |
| Packaging | Weather |
| Textiles | Publishing |
| Translation Services | Imaging |
| Training and Development | Small Business Information |
| Fundraising | Sports |
| Food and Beverage | Amusements and Attractions |
| Landscaping and Gardening | Toys |
| Apparel | Utilities |
| | Consulting |

### Data Matrix Construction and Transformation

In order to conduct topic analysis, input raw data records must be standardized. The message standardization process mainly converts message text to lowercase, eliminates irregular spacing, removes stops words, corrects spelling errors and replaces each word with its corresponding root. One matrix and two vectors may generally be used to specify term distribution information. The matrix A has n rows and m columns. Each row in A represent a term (word is special case of term) and each column in A represents a document in collection. The matrix A term is usually named as term-document frequency matrix.

$${A}_{n \times m} = ( \begin{matrix}{a}_{11} & {a}_{12} & … & {a}_{1 m} \\ {a}_{21} & {a}_{22} & … & {a}_{2 m} \\ … & … & … & … \\ {a}_{n 1} & {a}_{n 1} & … & {a}_{nm}\end{matrix} )$$

The value aᵢⱼ represent a term occurrence times in document j. The number of documents contain individual term is defined as vector D that represent the document frequency:

$${D}_{n \times 1} = ( \begin{matrix}{d}_{1} \\ {d}_{2} \\ … \\ {d}_{n}\end{matrix} )$$

Where dᵢ represents number documents that contain term I in current collection.

The total number term occurrence in whole collection is defined as collect frequency as follow:

$${C}_{n \times 1} = ( \begin{matrix}{c}_{1} \\ {c}_{2} \\ … \\ {c}_{n}\end{matrix} )$$

Where cᵢ represents term I occurrence in whole collection.

Table 3 provides further descriptions of data matrix and vectors.

TABLE 3
Data matrix and vectors definition

| Name | Symbol | Dimension | Description |
|---|---|---|---|
| Term | A | n by m | aᵢⱼ represents term i occurrence |
| frequency | | | times in document j |
| Document | D | n by 1 | dᵢ represents number documents |
| frequency | | | that contain term i |
| Collection | C | n by 1 | cᵢ represents term i occurrence |
| frequency | | | times in collection |

After collecting term-document frequency matrix, document and collection frequency vectors, these elements may be transformed and combined into a single entity for similarity calculation. One of the most popular methods for transformation is using Term Frequency and Inversed Document Frequency (TF-IDF), which basically changes relative weight on individual term based on total documents in collection and number documents that contain individual term. If W represents weighted matrix, then:

$${W}_{n \times m} = ( \begin{matrix}{w}_{11} & {w}_{12} & … & {w}_{1 m} \\ {w}_{21} & {w}_{22} & … & {w}_{2 m} \\ … & … & … & … \\ {w}_{n 1} & {w}_{n 2} & … & {w}_{nm}\end{matrix} )$$

### Where

$${w}_{ij} = {a}_{ij} \times {log}_{2} \frac{\vert D \vert}{{d}_{i}}$$

and |D| is the total documents in the collection.

After obtaining weighted data matrix, the column vector in the W matrix may be normalized. In general, any vector can be normalized by simply divide each element in the vector by the square root of all elements of the sum of the square.

Assume the square root of W column (i.e. sum of the square roots) is vector V:

$${V}_{1 \times m} = ( \begin{matrix}{v}_{1} & {v}_{2} & … & {v}_{m}\end{matrix} )$$

$$where {v}_{j} = {\sum }_{i = 1}^{n} {w}_{ij}$$

the allow the end product of transformation and normalization be T,

$${T}_{n \times m} = ( \begin{matrix}{t}_{11} & {t}_{12} & … & {t}_{1 m} \\ {t}_{21} & {t}_{22} & … & {t}_{2 m} \\ … & … & … & … \\ {t}_{n 1} & {t}_{n 2} & … & {t}_{nm}\end{matrix} )$$

$$where {t}_{ij} = {w}_{ij} \div {v}_{j}$$

The elements in each column of W are divided by square root of sum of square.

Let us use a simple example to illustrate how to normalize a vector. For example, assume vector Y_{1×4}=(1 3 6 2)

The square root of elements sum square=\sqrt{1²+3²+6²+2²}=\sqrt{1+9+36+4}=\sqrt{50} and normalized Y vector should be

$${Y}_{1 \times 4} = ( \begin{matrix}\frac{1}{\sqrt{50}} & \frac{3}{\sqrt{50}} & \frac{6}{\sqrt{50}} & \frac{2}{\sqrt{50}}\end{matrix} )$$

### Records Similarity and Clustering

Data input for topic or trend analysis is usually a set of random records collected from social media networks or any other sources. The set size can be as small as one or as big as millions or even billions. The input can be clustered into multiple groups based on the record similarity matrix. The record similarity matrix may be calculated as

$${S}_{m \times m} = ( \begin{matrix}{s}_{11} & {s}_{12} & … & {s}_{1 m} \\ {s}_{21} & {s}_{22} & … & {s}_{2 m} \\ … & … & … & … \\ {s}_{m 1} & {s}_{m 2} & … & {s}_{mm}\end{matrix} )$$

$$where {s}_{ij} = \frac{{\sum }_{k = 1}^{n} {t}_{ki} \times {t}_{kj}}{\sqrt{{\sum }_{k = 1}^{n} {t}_{ki}^{2}} \sqrt{{\sum }_{k = 1}^{n} {t}_{kj}^{2}}}$$

The elements in similarity matrix can have values between 0 and 1 to denote there is no relationship and completely identical, respectively. Any valid record should have a similarity index value of 1.0 with itself. Thus, the diagonal elements of matrix S should all be 1.0. Similarity matrix can be used to cluster records into separated groups. The similarity values for records inside a single group should be higher than the values for records outside the group.

The clustering process is usually conducted by ranking popularity index of each record. The popularity index is defined as number elements in each column of S that exceed predefined criteria. The most popular record is then selected as first cluster representation and all records exceed the criteria are recorded and eliminated from further selection. This implies that the current clustering methodology is exclusive and ignores possible overlap. The second most popular record is then selected as second cluster representation and a similar process is repeated until all records are exhausted or the popularity is below a preconfigured threshold. The cluster representation record is then used to calculate a similarity coefficient with each learned global hierarchical domain described above. The global hierarchical domain with the highest similarity coefficient is chosen as the current cluster domain context.

### Latent Semantic Analysis and Topic Exaction Algorithm:

Latent semantic analysis (LSA) is a robust unsupervised technique for deriving implicit text representation of text semantics based on terms and document distribution. This technology can be used to derive topic information for single or multiple records. Either weighted and normalized term-document matrix T, as described above, or simple term-document matrix A, are being used to introduce single value decomposition technique for topic analysis.

T_{n×m}=UΣV^{T}

where T is n by m weighted and normalized term-document matrix. After single value decomposition, U is n by n orthogonal matrix U^{T}U=I and V is m by m orthogonal matrix V^{T}V=I. Σ is a diagonal matrix with all elements being zero except the top p diagonal elements where p is the rank of matrix T. Further, U and V^{T} are considered unitary. Each column of U can be interpreted as a topic with each value in vector specifies the relative weight to corresponding term. Each topic is further weighted by diagonal elements in matrix Σ. The diagonal elements in matrix Σ are sorted and arranged in descending order. Thus, the first k columns in U may be picked up and multiplied by corresponding diagonal elements in Σ to obtain the topics words.

POS tag information should be used to identify nouns in a found term vector. The POS module is constructed using a huge amount of manually graded n-gram data. In one embodiment, the n-grams are purchased from the largest publicly-available, genre-balanced corpus of English—the 450-million-word Corpus of Contemporary American English (COCA), 1.8 billion words data from GloWnE and 1.9 billion words from 4.4 million Wikipedia articles. The data consists of three pieces of information: word sequences, frequency counts, and corresponding individual POS tags for the word sequences. The information is stored in POS module memory efficiently. The POS tag module is used to identify the POS tag for each term in found vector.

After determining which group of terms should exist in the topic, the nouns in the term vector are used to search and grab the most popular 1,000 web pages from search engine. It will be appreciated that fewer than 1,000 web pages or more than 1,000 web pages may be used. The relative order of terms is then calculated based on the contents of these web pages.

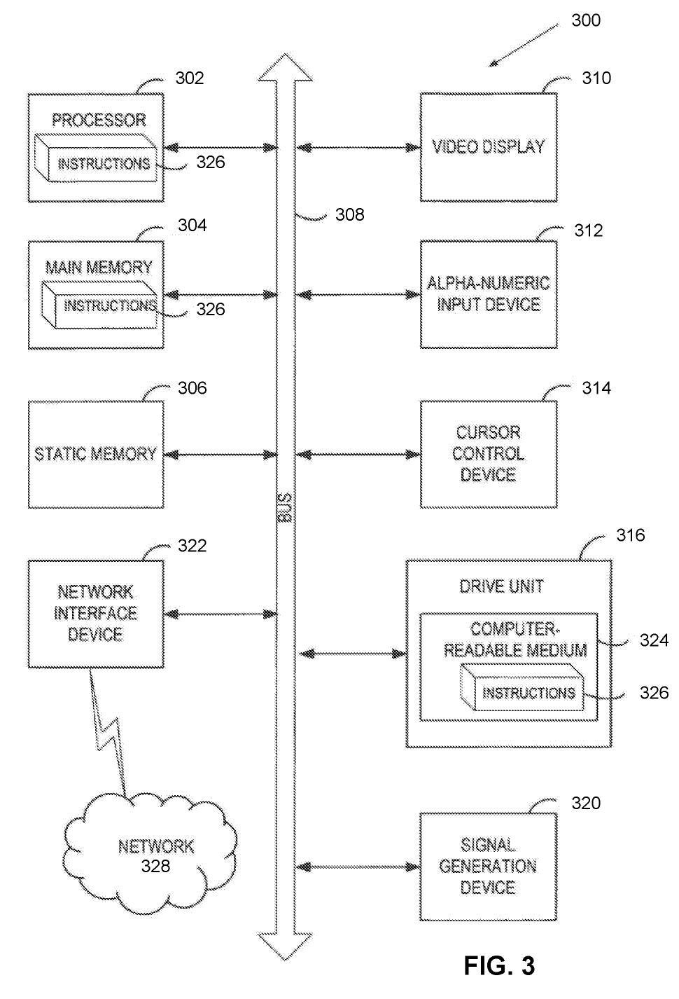

FIG. 3 shows a diagrammatic representation of machine in the exemplary form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, an access point, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 300 includes a processor 302 (e.g., a central processing unit (CPU), a graphics processing unit (GPU) or both), a main memory 304 (e.g., read only memory (ROM), flash memory, dynamic random access memory (DRAM) such as synchronous DRAM (SDRAM) or Rambus DRAM (RDRAM), etc.) and a static memory 306 (e.g., flash memory, static random access memory (SRAM), etc.), which communicate with each other via a bus 308.

The computer system 300 may further include a video display unit 310 (e.g., a liquid crystal display (LCD) or a cathode ray tube (CRT)). The computer system 300 also includes an alphanumeric input device 312 (e.g., a keyboard), a cursor control device 314 (e.g., a mouse), a disk drive unit 316, a signal generation device 320 (e.g., a speaker) and a network interface device 322.

The disk drive unit 316 includes a computer-readable medium 324 on which is stored one or more sets of instructions (e.g., software 326) embodying any one or more of the methodologies or functions described herein. The software 326 may also reside, completely or at least partially, within the main memory 304 and/or within the processor 302 during execution thereof by the computer system 300, the main memory 304 and the processor 302 also constituting computer-readable media.

The software 326 may further be transmitted or received over a network 328 via the network interface device 322.

While the computer-readable medium 324 is shown in an exemplary embodiment to be a single medium, the term “computer-readable medium” should be taken to include a single medium or multiple media (e.g., a centralized or distributed database, and/or associated caches and servers) that store the one or more sets of instructions. The term “computer-readable medium” shall also be taken to include any medium that is capable of storing, encoding or carrying a set of instructions for execution by the machine and that cause the machine to perform any one or more of the methodologies of the present invention. The term “computer-readable medium” shall accordingly be taken to include, but not be limited to, solid-state memories, and optical and magnetic media.

One or more of the methodologies or functions described herein may be embodied in a computer-readable medium on which is stored one or more sets of instructions (e.g., software). The software may reside, completely or at least partially, within memory and/or within a processor during execution thereof. The software may further be transmitted or received over a network.

It should be understood that components described herein include computer hardware and/or executable software code which is stored on a computer-readable medium for execution on appropriate computing hardware.

The terms “computer-readable medium” or “machine readable medium” should be taken to include a single medium or multiple media that store the one or more sets of instructions. The terms “computer-readable medium” or “machine readable medium” shall also be taken to include any non-transitory storage medium that is capable of storing, encoding or carrying a set of instructions for execution by a machine and that cause a machine to perform any one or more of the methodologies described herein. The terms “computer-readable medium” or “machine readable medium” shall accordingly be taken to include, but not be limited to, solid-state memories, and optical and magnetic media. For example, “computer-readable medium” or “machine readable medium” may include Compact Disc Read-Only Memory (CD-ROMs), Read-Only Memory (ROMs), Random Access Memory (RAM), and/or Erasable Programmable Read-Only Memory (EPROM). In other embodiments, some of these operations might be performed by specific hardware components that contain hardwired logic. Those operations might alternatively be performed by any combination of programmable computer components and fixed hardware circuit components.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

It should be understood that processes and techniques described herein are not inherently related to any particular apparatus and may be implemented by any suitable combination of components. Further, various types of general purpose devices may be used in accordance with the teachings described herein. The present invention has been described in relation to particular examples, which are intended in all respects to be illustrative rather than restrictive. Those skilled in the art will appreciate that many different combinations will be suitable for practicing the present invention.

Moreover, other implementations of the invention will be apparent to those skilled in the art from consideration of the specification and practice of the invention disclosed herein. Various aspects and/or components of the described embodiments may be used singly or in any combination. It is intended that the specification and examples be considered as exemplary only, with a true scope and spirit of the invention being indicated by the following claims.

What is claimed is:

1. A social media data clustering system comprising:
a topic analysis server for splitting input social media data into topics using topic analysis;
a frequency processor for generating a term-document frequency matrix, document and collection frequency vectors from the topics and transform the term-document frequency matrix and document and collection frequency vectors into a single entity for frequency calculations; and
a latent semantic analysis (LSA) processor for deriving implicit text representation of text semantics based on term and document distribution information generated by the frequency processor.

2. The social media data clustering system of claim 1, further comprising a source container, wherein the topic analysis server receives the social media data from the source container.

3. The social media data clustering system of claim 1, further comprising a target container, wherein the implicit text representation of text semantics derived by the LSA processor is stored in the target container.

4. A computer-implemented comprising:
generating a universal hierarchical topic domain dataset based on social media data records;
standardizing input raw social media data records;
clustering the standardized social media data records into multiple groups based on a record similarity matrix; and
deriving implicit text representation of text semantics based on latent semantic analysis (LSA) of the clustered social media data records.

5. The computer-implemented method of claim 4, wherein the multiple groups are clusters of topic domain data sets of the social media data records.

6. The computer-implemented method of claim 4, wherein the generating the universal hierarchical topic domain set is performed by a topic analysis server.

7. The computer-implemented method of claim 4, wherein the clustering the standardized social media data records into multiple groups based on a record similarity index is performed by a frequency processor.

8. The computer-implemented method of claim 4, wherein delivering implicit text representation of text semantics based on latent semantic analysis (LSA) is performed by a latent semantic analysis (LSA) processor.

9. The computer-implemented method of claim 4, further comprising using single value decomposition to detect topic words in the social media data records.

10. The computer-implemented method of claim 4, wherein the standardizing comprises at least one of converting text to lowercase, eliminating irregular spacing, removing stop words, correcting misspellings and replacing words with corresponding root words.

11. The computer-implemented method of claim 4, further comprising generating a term-document frequency matrix for each standardized social media data record.

12. The computer-implemented method of claim 11, further comprising transforming the term-document frequency matrix using term frequency and inversed document frequency (TF-IDF).

13. The computer-implemented method of claim 12, further comprising calculating the record similarity matrix using the transformed term-document frequency matrix.

14. The computer-implemented method of claim 12, further comprising clustering the data records by ranking a popularity index of each social media data record.

15. The computer-implemented method of claim 14, wherein the term-document frequency matrix is used to introduce a single value decomposition technique for topic analysis.

16. The computer-implemented method of claim 15, further comprising using POS tag information to identify nouns in the term-document frequency matrix.

17. The computer-implemented method of claim 16, wherein a POS tag module is used to define the POS tag information.

18. The computer-implemented method of claim 16, wherein the POS tag information is further used to retrieve most common web pages and topic word order.

19. The computer-implemented method of claim 4, wherein generating the universal hierarchical domain dataset uses web uniform resource locators (URLs) to control the generating.

20. The computer-implemented method of claim 11, wherein the term-document frequency matrix comprises average term distribution vectors.

21. The computer-implemented method of claim 20, wherein the group of each social media data record is determined by calculating a similarity index between each social media data record and each term distribution record.
